(19) United States
(12) Patent Application Publication
(10) Pub. No.: US 2012/0330672 A1
(43) Pub. Date: Dec. 27, 2012

(54) DYNAMIC BLIND COUNT FOR MEDICATION DISPENSING APPARATUS

(75) Inventors: TODD REED HENDERSON, LEAWOOD, KS (US); MARK DAVID GROMOWSKY, KANSAS CITY, MO (US)

(73) Assignee: CERNER INNOVATION, INC., OVERLAND PARK, KS (US)

(21) Appl. No.: 13/169,602

(22) Filed: Jun. 27, 2011

(51) Int. Cl. G06Q 50/00; G06F 17/00

(52) U.S. Cl. 705/2; 700/244

(57) ABSTRACT

A dynamic blind count setting is provided for dispensing medications from medication dispensing apparatuses. In some embodiments, when a dynamic blind count setting is provided for a medication at a medication dispensing apparatus, a blind count may be required at intervals of medication dispensing events such that a blind count is not required each time the medication is dispensed from the medication dispensing apparatus. The intervals may be random or scheduled. In some embodiments, a set point may be established for a medication such that blind counts are required when the system count for the medication reaches the set point.

### BACKGROUND

Many hospitals include a hospital pharmacy department that is responsible for dispensing medications to patients in various areas of the hospitals. In some hospitals, the medications are dispensed in a distributed environment with a central pharmacy (or multiple “central” pharmacies) and a number of medication dispensing apparatuses remotely situated in various locations throughout the hospital. The remotely-located medication dispensing apparatuses allow medications to be stored and dispensed closer to the location of patient care, which may provide a number of benefits, including simplifying and speeding up the process of clinicians obtaining medications for their patients.

Among other things, a hospital pharmacy department may be responsible for tracking the medications stored and dispensed by the various medication dispensing apparatuses throughout a hospital. This includes the responsibility for accounting for all narcotics that are stored, dispensed, and administered in the hospital. As a method of surveillance and record keeping, hospital pharmacy departments typically require a “blind count” function for dispensing narcotics from the medication dispensing apparatuses. The blind count requires a nurse or other clinician dispensing a narcotic to count the number of items of that narcotic in the medication dispensing apparatus or a compartment of the medication dispensing apparatus. Once the clinician counts the items of that narcotic, the clinician inputs that number into the system. The blind count is required to be performed each time the narcotic is dispensed. This ensures that any narcotic diversions are caught very quickly and that a perpetual inventory is kept for each narcotic, thus ensuring that counts are always accurate.

While blind counts are typically a necessary function when dealing with narcotics, blind counts are not typically part of the dispensing procedure for most non-narcotic medications as it is burdensome to the nursing staff or other clinicians dispensing medications. However, without the perpetual inventory benefit of a blind count, non-narcotic medication counts are often incorrect. This can be a result of diversion or benign mistakes that are not corrected by the nurses or other clinicians since there is low oversight for these types of medications. This may result in the inventory for medications running empty in medication dispensing apparatuses since the system still thinks the medications are in sufficient stock. This can affect not only the hospital pharmacy department (since they will need to respond quickly, which interrupts their workflow), but also patient care as medication administration may be delayed if the medication is unavailable.

### BRIEF SUMMARY

Embodiments of the present invention relate to employing dynamic blind counts for dispending medications from a medication dispensing apparatus. A dynamic blind count setting may be configured for a medication at a medication dispensing apparatus. Based on the dynamic blind count setting in accordance with some embodiments, a blind count may be required at random or scheduled intervals of medication dispensing events for the medication. As such, a blind count is not required each time a medication is dispensed. In some embodiments, a set point may be established for a medication such that blind counts are required when the system count for the medication reaches the set point.

Accordingly, in one aspect, an embodiment of the present invention is directed to one or more computer storage media storing computer-useable instructions that, when used by one or more computing devices, cause the one or more computing devices to perform a method. The method includes providing a dynamic blind count setting for a medication at a medication dispensing apparatus. The method also includes requiring blind counts to be performed by clinicians dispensing the medication at the medication dispensing apparatus at intervals of medication dispensing events for the medication in accordance with the dynamic blind count setting such that a blind count is not required at every medication dispensing event for the medication at the medication dispensing apparatus.

In another embodiment, an aspect is directed to one or more computer storage media storing computer-useable instructions that, when used by one or more computing devices, cause the one or more computing devices to perform a method. The method includes identifying initiation of a medication dispensing event to dispense a medication from a medication dispensing apparatus. The method also include determining, based on a dynamic blind count setting for the medication, whether a blind count is required for the medication dispensing event. If it is determined that a blind count is not required for the medication dispensing event, the method includes allowing the medication to be dispensed without a blind count. If it is determined that a blind count is required for the medication dispensing event, the method includes requiring a blind count before dispensing the medication.

A further embodiment is directed to one or more computer storage media storing computer-useable instructions that, when used by one or more computing devices, cause the one or more computing devices to perform a method. The method includes facilitating medication dispensing events to dispense a medication from a medication dispensing apparatus before a medication count for the medication reaches a set point. The method also includes determining that the medication count for the medication in the medication dispensing apparatus has reached the set point. The method further includes responsive to determining that the medication count has reached the set point, requiring blind counts for all medication dispensing events dispensing the medication from the medication dispensing apparatus.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a flow diagram showing a method for setting parameters for a medication at a medication dispensing apparatus including dynamic blind count settings in accordance with an embodiment of the present invention;

FIGS. 3A and 3B are screen displays showing user interfaces for entering parameters for a medication in accordance with an embodiment of the present invention;

FIG. 4 is a flow diagram showing a method for dispensing a medication using a dynamic blind count setting that requires blind counts at random or scheduled intervals in accordance with an embodiment of the present invention;

FIG. 5 is a flow diagram showing a method for employing dynamic blind count settings that require dynamic blind counts after a system count for the medication reaches a particular set point in accordance with another embodiment of the present invention;

FIG. 6 is a flow diagram showing a method for using dynamic blind count settings that include a combination of random or scheduled intervals and a set point in accordance with an embodiment of the present invention; and

FIG. 7 is a flow diagram showing a method for dispensing a medication during a medication dispensing event in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention allow the pharmacy department to set a dynamic blind count setting to select items for medication dispensing apparatuses. A dynamic blind count setting for a medication requires blind counts to be performed when dispensing the medication at intervals of medication dispensing events for the mediation. As such, a blind count is not required every time the medication is dispensed from the medication dispensing apparatus. When a blind count is required for a medication, the clinician is required to count the number of items in the medication dispensing apparatus or a compartment of the medication dispensing apparatus and to enter the count into the system prior to removing the requested amount. This offers the benefit of increasing oversight on the inventory levels of these medications, without burdening clinicians to count these medication items each time the medications are dispensed. In some embodiments, when a clinician accesses a medication and is asked to perform a blind count, the system will update the system count for the medication based on the clinician's input. Additionally, in some embodiments, a discrepancy report may be generated if the clinician-entered count doesn't match the system count.

Dynamic blind counts may be applied in a number of different manners within the scope of embodiments of the present invention. In some embodiments, random blind counts may be employed in which blind counts are required at random intervals. As such, clinicians dispensing medications will not know when blind counts will be required for the medications.

In some embodiments, scheduled blind counts may be employed in which blind counts are required at scheduled intervals. Dynamic blind counts may be set with even or uneven intervals. In some instances, the schedule may be a function of refill parameters for a medication (e.g., maximum level, refill level, critical level, etc.). As used herein, the “maximum level” for a medication represents an upper limit of how many individual items of a medication will be stored in a medication dispensing apparatus or a compartment of a medication dispensing apparatus. The “refill level” for a medication represents a number of items of the medication at which the medication will be refilled at a next medication refill event. The “critical level” for a medication refers to a number of items at which a medication refill is needed immediately.

By way of example, scheduled blind counts may be a function of the maximum level for a medication. For instance, suppose that a medication has a maximum level of 20 and a dynamic blind count is set at 75%, 50%, and 25% of the maximum count. Accordingly, a blind count would be required at medication dispensing events when the system count is 15, 10, and 5. A blind count would not be required at other times when the medication is dispensed. As another example, scheduled blind counts may be a function of both the maximum level and refill level. For instance, suppose that a medication has a maximum level of 20, a refill level of 8, and a dynamic blind count is set at 25% intervals. Based on these settings, a blind count would be required when the system count for the medication is 17, 14, and 11.

In some embodiments, the dynamic blind count may be set as a function of the current system count for a medication. Suppose, for instance, that a dynamic blind count is set at 75% of current system count starting at the maximum level and whenever a blind count is required. Suppose further that the maximum level for the medication is 20. Blind counts would be required when the system count is 15 (75% of 20), 11 (about 75% of 15), 8 (about 75% of 11), and 6 (75% of 8). This approach allows for more frequent blind counts as the number of medication items decreases.

In some instances, a scheduled blind count may be independent of refill parameters or a current system count. For instance, a blind count may simply be required at every other or every third medication dispensing event for a medication. As another example, a blind count may be required each time after a certain number of items have been dispensed. For instance, a blind count may be required each time after three items have been cumulatively dispensed.

In still further embodiments, dynamic blind counts could be triggered when the system count for a medication reaches a certain set point. For instance, suppose a medication is configured with a dynamic blind count setting with a set point of 12. No blind count may be required before the system count reaches 12. When the system count reaches 12, a blind count may be required at every medication dispensing event for the medication until the medication is refilled. The set point may be manually set, randomly set, or determined as a function of refill parameters or other basis.

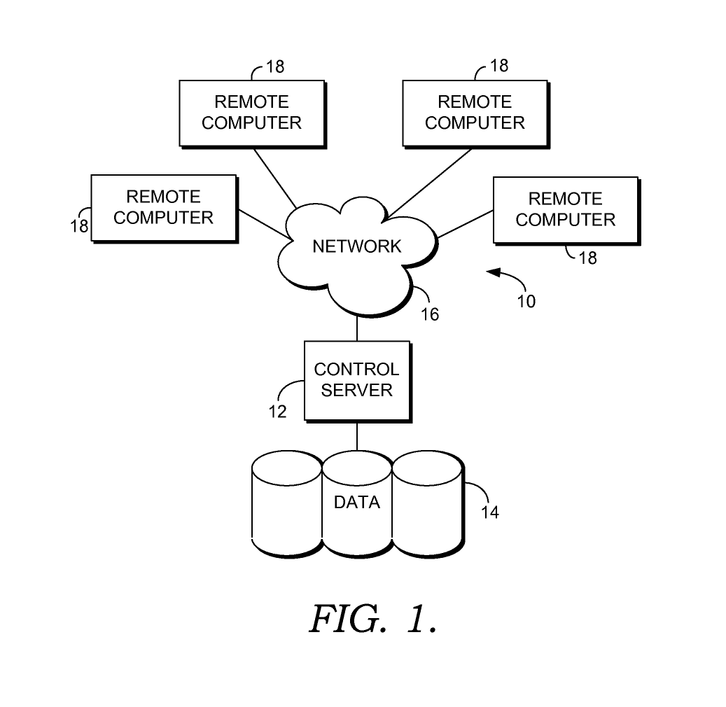

Referring to the drawings in general, and initially to FIG. 1 in particular, an exemplary computing system environment, for instance, a medical information computing system, on which embodiments of the present invention may be implemented is illustrated and designated generally as reference numeral 10. It will be understood and appreciated by those of ordinary skill in the art that the illustrated medical information computing system environment 10 is merely an example of one suitable computing environment and is not intended to suggest any limitation as to the scope of use or functionality of the invention. Neither should the medical information computing system environment 10 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 10 includes a general purpose computing device in the form of a server 12. Components of the server 12 may include, without limitation, a processing unit, internal system memory, and a suitable system bus for coupling various system components, including database cluster 14, with the server 12. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 12 typically includes, or has access to, a variety of computer readable media, for instance, database cluster 14. Computer readable media can be any available media that may be accessed by server 12, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 12. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 14, provide storage of computer readable instructions, data structures, program modules, and other data for the server 12.

The server 12 may operate in a computer network 16 using logical connections to one or more remote computers 18. Remote computers 18 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 18 may also be physically located in non-traditional medical care environments so that the entire health care community may be capable of integration on the network. The remote computers 18 may be personal computers, servers, routers, network PCs, peer devices, other common network nodes, or the like, and may include some or all of the components described above in relation to the server 12. The devices can be personal digital assistants or other like devices.

Exemplary computer networks 16 may include, without limitation, local area networks (LANs) and/or wide area networks (WANs). Such networking environments are commonplace in offices, enterprise-wide computer networks, intranets, and the Internet. When utilized in a WAN networking environment, the server 12 may include a modem or other means for establishing communications over the WAN, such as the Internet. In a networked environment, program modules or portions thereof may be stored in the server 12, in the database cluster 14, or on any of the remote computers 18. For example, and not by way of limitation, various application programs may reside on the memory associated with any one or more of the remote computers 18. It will be appreciated by those of ordinary skill in the art that the network connections shown are exemplary and other means of establishing a communications link between the computers (e.g., server 12 and remote computers 18) may be utilized.

In operation, a user may enter commands and information into the server 12 or convey the commands and information to the server 12 via one or more of the remote computers 18 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 12. In addition to a monitor, the server 12 and/or remote computers 18 may include other peripheral output devices, such as speakers and a printer.

Although many other internal components of the server 12 and the remote computers 18 are not shown, those of ordinary skill in the art will appreciate that such components and their interconnection are well known. Accordingly, additional details concerning the internal construction of the server 12 and the remote computers 18 are not further disclosed herein.

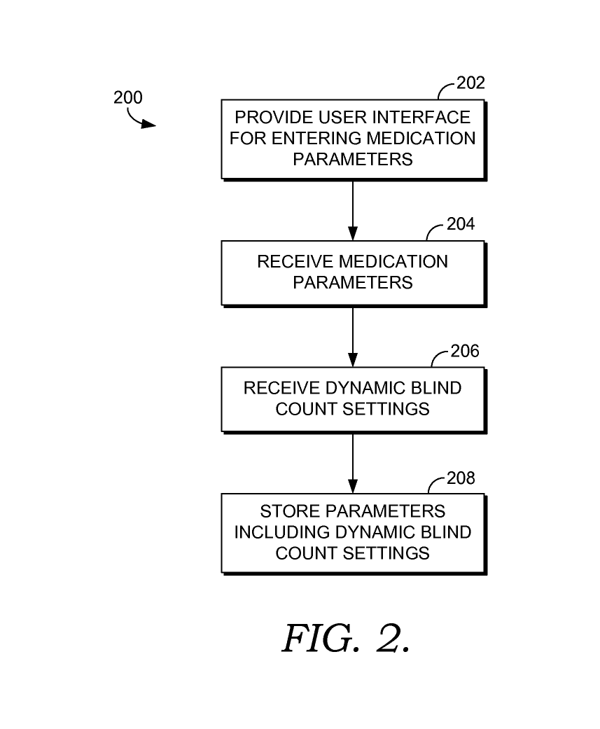

Turning now to FIG. 2, a flow diagram is provided that illustrates a method 200 for setting parameters for a medication at a medication dispensing apparatus to include a dynamic blind count for the medication in accordance with an embodiment of the present invention. As shown at block 202, a user interface for entering medication parameters for a particular medication at a particular medication dispensing apparatus is provided. The user interface may be presented to a user via any computing device that is given access to setting parameters for that medication and medication dispensing apparatus. By way of example only and not limitation, this may include a computing device integral with the medication dispensing apparatus, a computing device located in a central pharmacy, or a computing device remote from the central pharmacy. The user interface may be provided in response to a user command to access parameters for a particular medication at a particular medication dispensing apparatus.

Parameters for the identified medication and identified medication dispensing apparatus are received via the user interface, as shown at block 204. The parameters may include, for instance, refill parameters, which may include a maximum level, a default refill level, and a critical level for the medication. Other parameters for the medication may also be entered via the user interface. As shown at block 206, dynamic blind count settings are also entered via the user interface. In some embodiments, the user interface may be configured to allow selection from different dynamic blind count settings. For instance, the dynamic blind count setting may include random blind count settings, scheduled blind count settings, set point blind count settings, or any combination thereof. The medication parameters, including the dynamic blind count settings, entered via the user interface are stored, as shown at block 208. The information may be stored locally at the medication dispensing apparatus or remotely at a central database provided at a central pharmacy or another location.

Although the method 200 was discussed in the context of setting dynamic blind count settings and other parameters for a particular medication at a particular medication dispensing apparatus (i.e., single medication for a single medication dispensing apparatus), it should be understood that similar methods may be employed on a more aggregate level to simultaneously set dynamic blind count settings and other parameters for multiple different types of medications and/or for multiple different medication dispensing apparatuses. For instance, the dynamic blind count settings for a particular type of medication may be simultaneously set for a number of medication dispensing apparatuses containing that type of medication. As another example, the dynamic blind count settings for various types of medications in a medication dispensing apparatus may be simultaneously set for that medication dispensing apparatus. As still another example, global dynamic blind count settings may be set that apply to all medications at all medication dispensing apparatuses within a healthcare facility. Any and all such variations are contemplated to be within the scope of embodiments of the present invention.

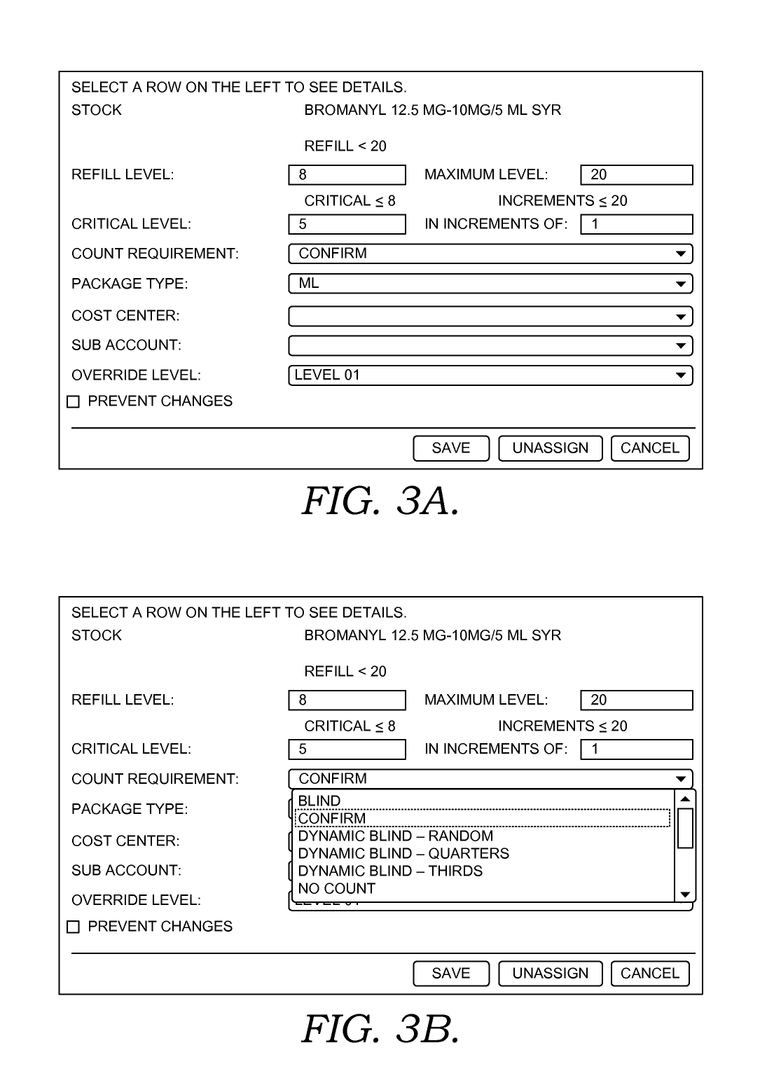

FIGS. 3A and 3B illustrate example screen shots showing user interfaces for entering parameters for a medication. It will be understood and appreciated by those of ordinary skill in the art that the screen displays of FIGS. 3A and 3B are provided by way of example only and are not intended to limit the scope of the present invention in any way.

With initial reference to FIG. 3A, a medication parameter user interface is shown for the medication: “Bromanyl 12.5 mg-10 mg/5 mL syr.” The medication parameter user interface allows a clinician, administrator, or other authorized personnel to set various parameters for the indicated medication. The user interface may be associated with a single medication dispensing apparatus, subset of medication dispensing apparatuses, or all medication dispensing apparatuses within a healthcare facility.

As shown in FIG. 3A, the user interface includes a number of refill parameters, such as a refill level (which has been set at 8), a maximum level (which has been set at 20), and a critical level (which has been set at 5). Based on these settings, when the medication count in a medication dispensing apparatus is determined during a scheduled refill report process to be below 8 (i.e., the refill level), an indication to refill the medication dispensing apparatus is provided for the medication. Additionally, if the medication falls below 5 (i.e., the critical level) at any time, an indication to refill the medication dispensing apparatus is provided for the medication. The refill amount may be based on the current medication count and the maximum level (i.e., 20). For instance, if the medication count is currently 6, the refill amount for the medication may be 14 to bring the medication count to the maximum level of 20.

The medication parameter user interface in FIG. 3A also includes a number of additional parameters for the indicated medication. These parameters include: count requirement, package type, cost center, sub account, and override level. Additionally, an option to prevent changes to the refill parameters may be selected by a user with particular privileges to prevent others from changing the refill parameters.

The count requirement option allows a user to set forth a type of count required by users during medication dispensing events. In accordance with embodiments of the present invention, the count requirement allows a user to set dynamic blind count settings for a medication. In particular, a user may select the count requirement feature and a drop down box such as that shown in FIG. 3B may be provided. As shown in FIG. 3B, a number of count requirement options are provided, including a blind option, a confirm option, dynamic blind—random option, a dynamic blind—quarters option, a dynamic blind—thirds option, a no count option. If the blind option is set for the medication, a blind count would be required at every medication dispensing event for the medication. If the confirm option is selected, a confirm count is set for the medication such that during medication dispensing events, the system displays the system count for the medication and prompts the clinician dispensing the medication to confirm the count. If one of the dynamic blind count options is selected, a blind count would be required at different intervals of medication dispensing events for the medication. For instance, if the dynamic blind—random option is selected, a blind count would be required at random intervals of medication dispensing events for the medication. If the dynamic blind—quarters option is selected, a blind count would be required when the system count is at 75%, 50%, and 25% of the maximum refill level for the medication. If the dynamic blind—thirds option is select, a blind count would be required when the system count is at 66% and 33% of the maximum level for the medication. Finally, the confirm requirement options shown in FIG. XB include a no count option. If the no count option is selected, no count would be required for medication dispensing events for the medication. It should be understood that the count requirement options shown in FIG. 3B are provided by way of example only and should not be viewed as limiting. For instance, other types of dynamic blind count settings may be provided via the user interface. Further, in some embodiments, the user interface may allow for the entry of custom dynamic blind settings by a user.

After a medication dispensing apparatus has been filled with medications and parameters set for the medications, clinicians may dispense medications from the medication dispensing apparatus. When clinicians dispense medications from the medication dispensing apparatus, a count may be required according to the count requirement settings for each medication. In accordance with embodiments of the present invention, a dynamic blind count setting may be established for a medication such that a blind count is not required at every medication dispensing event for the medication. Instead, a blind count may be required at random intervals, scheduled intervals, and/or when a system count for the medication reaches a particular set point.

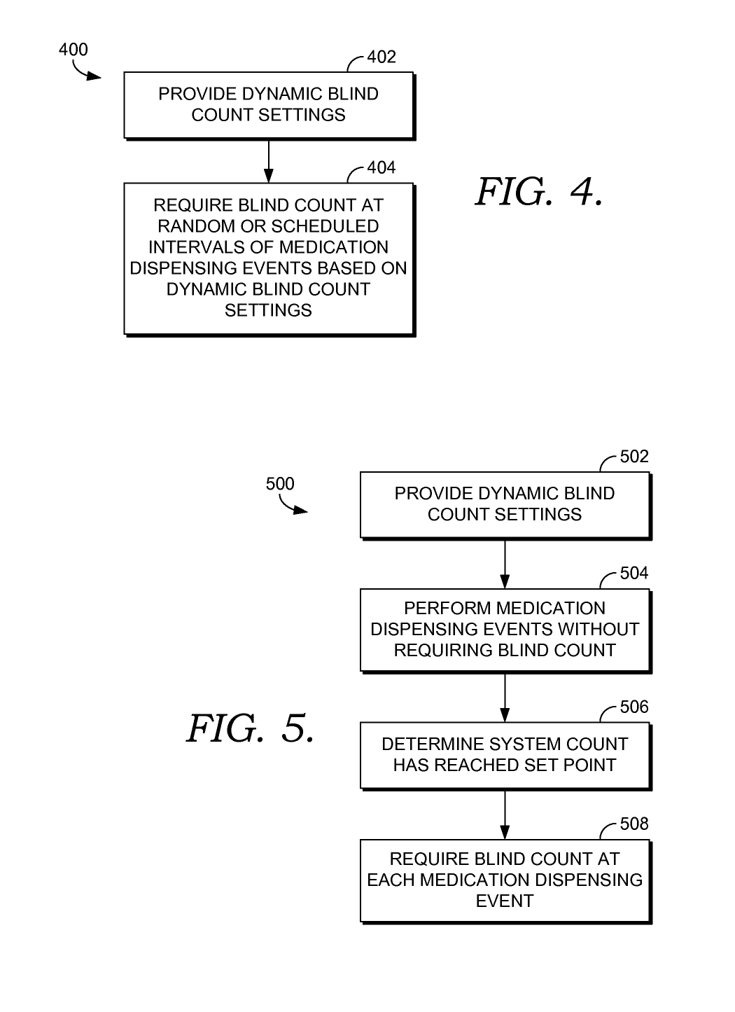

With reference now to FIG. 4, a flow diagram is provided that illustrates a method 400 for dispensing a medication using a dynamic blind count setting that requires blind counts at random or scheduled intervals in accordance with an embodiment of the present invention. As shown at block 402, dynamic blind count settings are provided. The dynamic blind count settings may be provided, for instance, using the method 200 described above with reference to FIG. 2. The dynamic blind count settings may set forth a blind count requirement at random intervals or scheduled intervals of medication dispensing events.

Based on the dynamic blind count settings, blind counts are required at random or scheduled intervals of medication dispensing events for the medication at the medication dispensing apparatus, as shown at block 404. As such, a blind count is not required at each medication dispensing event for the medication event. Instead, the system will require blind counts only at intervals of medication dispensing events in accordance with the dynamic blind count settings set forth for the medication. At medication dispensing events in which a dynamic blind count is not required, the medication may be dispensed with no count or with a confirm count.

Turning next to FIG. 5, a flow diagram is provided that illustrates a method 500 for employing dynamic blind count settings that require dynamic blind counts after a system count for the medication reaches a particular set point in accordance with an embodiment of the present invention. As shown at block 502, dynamic blind count settings are provided. The dynamic blind count settings may be provided, for instance, using the method 200 described above with reference to FIG. 2. The dynamic blind count settings may set forth a set point after which blind counts are required for each medication dispensing event. The set point may be a user-defined quantity, a quantity calculated based on some refill parameter, or may be defined on some other basis.

As shown at block 504, medication dispensing events for the medication are initially performed without requiring a blind count. At each of these medication dispensing events, the medication may be dispensed either with no count or with a confirm count. As the medication is dispensed, the system maintains a system count for the medication at the medication dispensing apparatus (which may be updated by user counts). At some time, the system determines that the system count for the medication at the medication dispensing apparatus has reached a particular set point, as shown at block 506. After determining that the system count has reached the set point, a blind count is required at each medication dispensing event for the medication at the medication dispensing apparatus, as shown at block 508. In some embodiments, instead of requiring a blind count at every medication dispensing event for the medication after the system count reaches the set point, a blind count may be required at random or scheduled intervals after the system count has reached the set point. This may continue until the next time the medication is refilled.

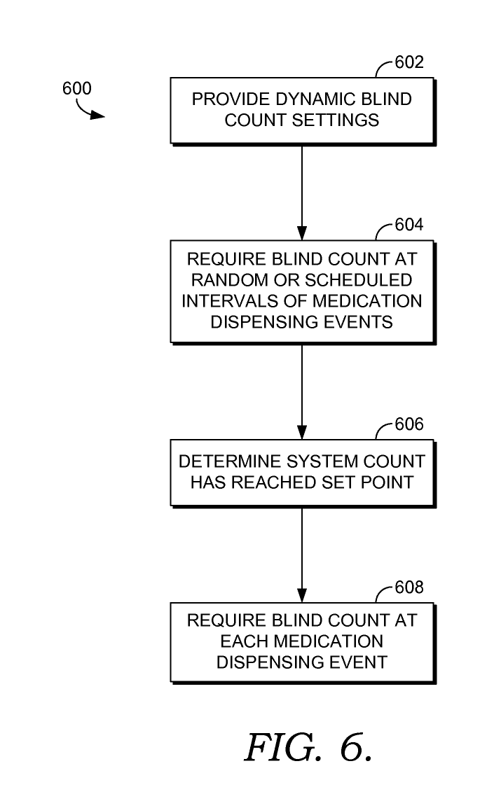

In some embodiments, the dynamic blind count settings may include both an interval and set point approach. In particular, blind counts may be required at random or scheduled intervals when the system count is above a particular set point. When the system count reaches the set point, a blind count is required for each medication dispensing event. This is illustrated in FIG. 6, which shows a method 600 for using dynamic blind count settings that include a combination of random or scheduled intervals and a set point in accordance with an embodiment of the present invention. As shown at block 602, dynamic blind count settings are provided. The dynamic blind count settings may be provided, for instance, using the method 200 described above with reference to FIG. 2. In accordance with the present embodiment, the dynamic blind count settings may set forth a random or scheduled interval for blind counts and a set point.

Based on the dynamic blind count settings, blind counts are required at random or scheduled intervals of medication dispensing events for the medication at the medication dispensing apparatus, as shown at block 604. As such, a blind count is not required at each medication dispensing event for the medication event. Instead, the system will require blind counts only at intervals of medication dispensing events in accordance with the dynamic blind count settings set forth for the medication. At medication dispensing events in which a dynamic blind count is not required, the medication may be dispensed with no count or with a confirm count.

As the medication is dispensed, the system maintains a system count for the medication at the medication dispensing apparatus (which may be updated by user counts). At some time, the system determines that the system count for the medication at the medication dispensing apparatus has reached a particular set point, as shown at block 606. After determining that the system count has reached the set point, a blind count is required at each medication dispensing event for the medication at the medication dispensing apparatus, as shown at block 608.

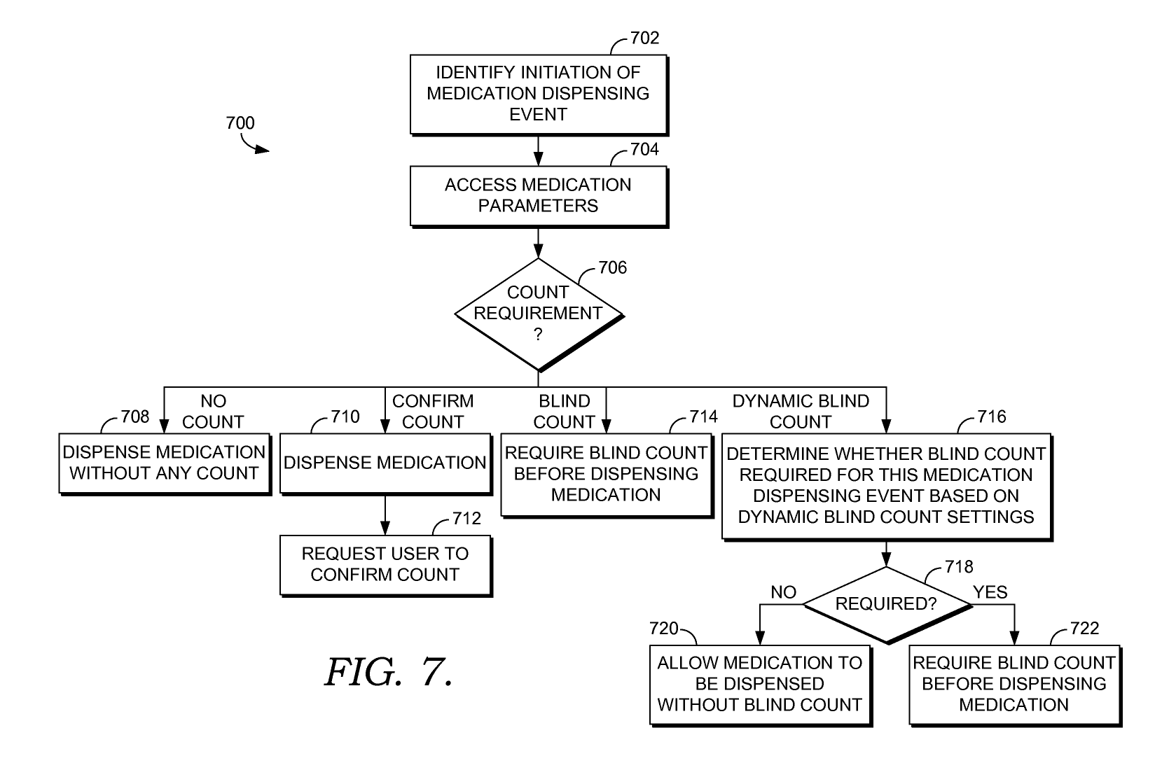

Referring now to FIG. 7, a flow diagram is provided that illustrates a method 700 for dispensing a medication during a medication dispensing event in accordance with an embodiment of the present invention. Initially, as shown at block 702, the initiation of a medication dispensing event is identified. This may occur when a clinician, such as a nurse, accesses a medication dispensing apparatus to dispense a particular medication. Parameters for the medication are accessed, as shown at block 704. The parameters may be stored at and accessed from a computing device integral with the medication dispensing apparatus. Alternatively, the parameters may be stored at and accessed from a remote location, such as a central pharmacy data store that stores data for managing pharmacy activities at the healthcare facility.

The count requirement settings for the medication are determined from the medication parameters, as shown at block 706. In particular, a number of count requirement options may have been available for the medication, including a no count option, a confirm count option, a blind count option, and a blind count option. If it is determined that a no count option was set for the medication, the medication is dispensed from the medication dispensing apparatus with any count, as shown at block 708. If it is determined that a confirm count option was set for the medication, the medication is dispensed, as shown at block 710, and the clinician is requested to confirm a system count for the medication that is presented to the clinician, as shown at block 712. If a blind count option is set for the medication, a blind count is required before the medication is dispensed, as shown at block 714.

If a dynamic blind count option is selected for the medication, a determination is made at block 716 regarding whether a blind count is required for this particular medication dispensing event. The determination would be made in accordance with the dynamic blind count settings specified for the medication. For instance, if the dynamic blind count settings include scheduled intervals at 75%, 50%, and 25% of the maximum count for the medication, the system would determine whether the current system count is at 75%, 50%, or 25% of the maximum count.

If it is determined at block 718 that a blind count is not required for the current medication dispensing event, the medication is dispensed without requiring a blind count, as shown at block 720. This may include dispensing the medication with no count or with a confirm count. Alternatively, if it is determined at block 718 that a blind count is required for the current medication dispensing event, a blind count is required before the medication is dispensed, as shown at block 722.

As can be understood, embodiments of the present invention provide for a dynamic blind count for medication dispensing in which a blind count is required at scheduled or random intervals of medication dispensing events for a medication such that a blind count is not required for all medication dispensing events for the medication. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform a method, the method comprising:
providing a dynamic blind count setting for a medication at a medication dispensing apparatus; and
requiring blind counts to be performed by clinicians dispensing the medication at the medication dispensing apparatus at intervals of medication dispensing events for the medication in accordance with the dynamic blind count setting such that a blind count is not required at every medication dispensing event for the medication at the medication dispensing apparatus.

2. The one or more computer storage media of claim 1, wherein the dynamic blind count setting for the medication comprises a random blind count setting such that blind counts are required to be performed by clinicians dispensing the medication at the medication dispensing apparatus at random intervals of medication dispensing events.

3. The one or more computer storage media of claim 1, wherein the dynamic blind count setting for the medication comprises a scheduled blind count setting such that blind counts are required to be performed by clinicians dispensing the medication at the medication dispensing apparatus at scheduled intervals of medication dispensing events.

4. The one or more computer storage media of claim 3, wherein the scheduled blind count setting specifies scheduled intervals independent of refill parameters for the medication.

5. The one or more computer storage media of claim 3, wherein the scheduled blind count setting specifies scheduled intervals as a function of refill parameters for the medication.

6. The one or more computer storage media of claim 3, wherein the scheduled intervals are evenly distributed.

7. The one or more computer storage media of claim 1, wherein providing the dynamic blind count setting for the medication at the medication dispensing apparatus comprises:
providing a user interface allowing for entry of a plurality of parameters for the medication for the medication dispensing apparatus;
receiving the dynamic blind count setting for the medication; and
storing the dynamic blind count setting for the medication.

8. The one or more computer storage media of claim 1, wherein the method further comprises:
determining that a medication count for the medication at the medication dispensing apparatus has reached a set point; and
responsive to determining that the medication count for the medication at the medication dispensing apparatus has reached the set point, requiring blind counts to be performed by clinicians dispensing the medication at the medication dispensing apparatus at every medication dispensing events for the medication.

9. The one or more computer storage media of claim 1, wherein the method further comprises performing medication dispensing events at which no blind count is required by employing no count or a confirm count.

10. One or more computer storage media storing computer-useable instructions that, when used by one or more computing devices, cause the one or more computing devices to perform a method, the method comprising:
identifying initiation of a medication dispensing event to dispense a medication from a medication dispensing apparatus;
determining, based on a dynamic blind count setting for the medication, whether a blind count is required for the medication dispensing event;
if it is determined that a blind count is not required for the medication dispensing event, allowing the medication to be dispensed without a blind count; and
if it is determined that a blind count is required for the medication dispensing event, requiring a blind count before dispensing the medication.

11. The one or more computer storage media of claim 10, wherein the dynamic blind count setting for the medication comprises a random blind count setting such that blind counts are required to be performed by clinicians dispensing the medication at the medication dispensing apparatus at random intervals of medication dispensing events.

12. The one or more computer storage media of claim 10, wherein the dynamic blind count setting for the medication comprises a scheduled blind count setting such that blind counts are required to be performed by clinicians dispensing the medication at the medication dispensing apparatus at scheduled intervals of medication dispensing events.

13. The one or more computer storage media of claim 12, wherein the scheduled blind count setting specifies scheduled intervals as a function of refill parameters for the medication.

14. The one or more computer storage media of claim 10, wherein the dynamic blind count setting for the medication comprises a set point in which a blind count is required for every medication dispensing event for the medication when a system count for the medication reaches the set point.

15. One or more computer storage media storing computer-useable instructions that, when used by one or more computing devices, cause the one or more computing devices to perform a method, the method comprising:
facilitating medication dispensing events to dispense a medication from a medication dispensing apparatus before a medication count for the medication reaches a set point;
determining that the medication count for the medication in the medication dispensing apparatus has reached the set point; and
responsive to determining that the medication count has reached the set point, requiring blind counts for all medication dispensing events dispensing the medication from the medication dispensing apparatus.

16. The one or more computer storage media of claim 15, wherein the set point is manually set by a user setting refill parameters for the medication.

17. The one or more computer storage media of claim 15, wherein the set point is automatically determined.

18. The one or more computer storage media of claim 17, wherein the set point is automatically determined as a function of refill parameters for the medication.

19. The one or more computer storage media of claim 15, wherein facilitating the medication dispensing events to dispense a medication from a medication dispensing apparatus before a medication count for the medication reaches a set point comprises requiring blind counts to be performed by clinicians dispensing the medication at the medication dispensing apparatus at intervals of medication dispensing events for the medication in accordance with a dynamic blind count setting such that a blind count is not required at every medication dispensing event for the medication at the medication dispensing apparatus.

20. The one or more computer storage media of claim 15, wherein facilitating the medication dispensing events to dispense a medication from a medication dispensing apparatus before a medication count for the medication reaches a set point comprises performing medication dispensing events using no count or a confirm count.
